(19) United States
(12) Patent Application Publication
(10) Pub. No.: US 2024/0177501 A1
(43) Pub. Date: May 30, 2024

(54) METHOD AND DEVICE FOR DETECTING THE END OF A JOURNEY OF A VEHICLE

(71) Applicant: Robert Bosch GmbH, Stuttgart (DE)

(72) Inventors: Masato Takami, Hildesheim (DE); Fabian Brickwedde, Braunschweig (DE); Uwe Brosch, Algermissen (DE)

(21) Appl. No.: 18/519,705

(22) Filed: Nov. 27, 2023

(30) Foreign Application Priority Data
Nov. 30, 2022 (DE) 10 2022 212 836.2

(51) Int. Cl. G06V 20/59; G06V 10/82; G06V 20/40; G06V 40/10; G08G 1/04

(52) U.S. Cl. CPC G06V 20/59; G06V 10/82; G06V 20/41; G06V 40/10; G08G 1/04

(57) ABSTRACT

A method for detecting an end of a journey of a vehicle. The method includes: determining a movement of the vehicle; determining a closing of at least one door of the vehicle; determining an entry and/or an exit of one or more persons into or from the vehicle; detecting the end of the journey of the vehicle when it is determined that the movement of the vehicle is zero, and when a closing of at least the one door of the vehicle is determined, and when an entry and/or an exit of the one or more persons into or from the vehicle is detected.

### CROSS REFERENCE

The present application claims the benefit under 35 U.S.C. § 119 of German Patent Application No. DE 10 2022 212 836.2 filed on Nov. 30, 2022, which is expressly incorporated herein by reference in its entirety.

### BACKGROUND INFORMATION

German Patent Application No. DE 10 2014 214 352 A1 describes a method and an arrangement for operating an occupant observation system.

### SUMMARY

The present invention provides a method for detecting an end of a journey of a vehicle. According to an example embodiment of the present invention, the method includes the following steps: determining a movement of the vehicle,

determining a closing of at least one door of the vehicle, determining an entry and/or an exit of one or more persons into or from the vehicle,

detecting the end of the journey of the vehicle, when it is determined that the movement of the vehicle is equal to zero, and

when a closing of at least one door of the vehicle is determined, and

when an entry and/or an exit of the one or more persons into or from the vehicle is detected.

An advantage of the present method is that a journey or an end of a journey can be detected simply, safely and/or reliably. The end of the journey can advantageously be detected in particular in a time-accurate manner. The method can preferably be used in different vehicles independently of a vehicle type.

Advantageously, detection can take place automatically. As a result, the end of the journey in particular does not have to be confirmed manually, for example by a vehicle occupant. By using the three criteria, which are connected to an AND operation, the method is preferably designed to be robust, whereby erroneous messages can advantageously be prevented. As a result, a journey detection can be carried out in particular safely and/or reliably.

In an exemplary embodiment of the present invention, the method can further comprise the steps of receiving movement data of the vehicle, receiving monitoring data of a closing of at least one door of the vehicle and receiving observation data of a vehicle interior. In this way, the corresponding data required for processing can in particular be received safely and/or reliably. In this way, the end of a journey can in particular be detected simply, safely and/or reliably.

In a further development of the present invention, the method further comprises the step of observing a vehicle interior in order to generate observation data for determining an entry and/or an exit of one or more persons into or from the vehicle and/or for determining a movement of the vehicle. In this way, observation data can in particular be safely and/or reliably determined, whereby in particular an entry and/or an exit of persons and/or a movement of the vehicle can be determined safely and/or reliably. In this way, the end of a journey can in particular be detected simply, safely and/or reliably.

Furthermore, according to an example embodiment of the present invention, the method can advantageously comprise a step of measuring acceleration data and determining an orientation of the vehicle in order to determine a movement of the vehicle and/or to determine a closing of at least one door of the vehicle. In this way, acceleration data and an orientation of the vehicle can be determined in particular safely and/or reliably, as a result of which a movement of the vehicle and/or a closing of at least one door of the vehicle can be determined in particular safely and/or reliably. In this way, the end of a journey can in particular be detected simply, safely and/or reliably.

In an advantageous embodiment of the present invention, the movement of the vehicle can be determined by means of acceleration data and an orientation of the vehicle and/or by means of data of a navigation system and/or by means of observation data. As a result, a vehicle movement can be determined in particular simply and/or reliably, as a result of which the end of a journey can be detected in particular simply, safely and/or reliably.

Furthermore, according to an example embodiment of the present invention, a closing of at least the one door of the vehicle can be determined in particular by means of acceleration data of the vehicle and/or by means of audio data and/or by means of observation data. As a result, a closing of at least the one door of the vehicle can be determined in particular simply and/or reliably, whereby the end of a journey can be detected in particular simply, safely and/or reliably.

In one exemplary embodiment of the present invention, an entry and/or an exit of the one or more persons into or from the vehicle can be determined by means of video-based person recognition. As a result, persons can thereby be in particular reliably detected or identified. It is thus possible to detect whether and which persons exit and whether the same or different persons enter again. As a result, it can be reliably determined whether one or more persons enter or exit. In this way, the end of a journey can in particular be detected simply, safely and/or reliably.

Advantageously, according to an example embodiment of the present invention, an evaluation of observation data in order to determine an entry and/or an exit of one or more persons into or from the vehicle can be learned by means of a neural network. As a result, the neural network can be trained, whereby the evaluation of the observation data becomes more reliable and/or more robust. For example, hidden regions can be detected and learned in this way. As a result, it can in particular be detected safely and/or reliably whether one or more persons enter or exit the vehicle. In this way, the end of a journey can in particular be detected simply, safely and/or reliably.

In an advantageous embodiment of the present invention, a start of the journey can then be determined after it has been determined that the movement of the vehicle is equal to zero and after a closing of the door of the vehicle has been determined and after it has been detected that one or more persons have exited and/or entered the vehicle. Alternatively or additionally, after the end of the journey has been determined, a start of a further journey of the vehicle can be determined. In a development, an end of the further journey can be determined when it is determined again that the movement of the vehicle is zero and when a closing of at least one door of the vehicle is determined again and when an entry and/or an exit of one or more persons into or from the vehicle is detected. This makes it possible, in particular, to detect a closed journey cycle. In other words, a journey detection with a start and an end of the journey can in particular be detected easily, safely and/or reliably.

Furthermore, according to an example embodiment of the present invention, a device for detecting an end of a journey of a vehicle is provided, the device being designed

for determining a movement of the vehicle,

for determining a closing of at least one door of the vehicle, for determining an entry and/or an exit of one or more persons into or from the vehicle, and

for detecting the end of the journey of the vehicle when it is determined that the movement of the vehicle is equal to zero, and

when a closing of at least the one door of the vehicle is determined, and

when an entry and/or an exit of the one or more persons into or from the vehicle is detected.

An advantage is that a journey or an end of a journey can be detected in particular simply, safely and/or reliably.

Advantageously, the end of the journey can be detected in particular in a time-accurate and/or automatic manner. The method can preferably be used in different vehicles independently of a vehicle type. By using the three criteria, which are connected to an AND operation, the method is preferably designed to be robust, whereby erroneous messages can advantageously be prevented. As a result, a journey detection can be carried out in particular safely and/or reliably.

In a further development of the present invention, the device can comprise an observation device for observing a vehicle interior in order to generate observation data for determining an entry and/or an exit of one or more persons into or from the vehicle and/or for determining a movement of the vehicle. In this way, observation data can in particular be safely and/or reliably determined, whereby in particular an entry and/or an exit of persons and/or a movement of the vehicle can be determined safely and/or reliably. In this way, the end of a journey can in particular be detected simply, safely and/or reliably.

In one exemplary embodiment of the present invention, the device can comprise a measuring unit for measuring acceleration data and an orientation of the vehicle in order to determine a movement of the vehicle and/or in order to determine a closing of at least the one door of the vehicle. In this way, acceleration data and an orientation of the vehicle can be determined in particular safely and/or reliably, as a result of which a movement of the vehicle and/or a closing of at least one door of the vehicle can be determined in particular safely and/or reliably. In this way, the end of a journey can in particular be detected simply, safely and/or reliably.

According to an example embodiment of the present invention, a vehicle is provided with a device according to the present invention for detecting an end of a journey of a vehicle.

### BRIEF DESCRIPTION OF THE DRAWINGS

Exemplary embodiments of the present invention are illustrated in the figures and explained in more detail in the following description. The same reference signs are used for the elements shown in the various figures and acting similarly, whereby a repeated description of the elements is dispensed with.

FIG. 1 is a schematic representation of a vehicle comprising a device for observing a vehicle occupant, according to an example embodiment of the present invention.

FIG. 2 shows a schematic representation of a method according to an exemplary embodiment of the present invention.

FIG. 3 shows a schematic representation of a method according to an exemplary embodiment of the present invention.

FIG. 4 shows a schematic representation of a method according to an exemplary embodiment of the present invention.

FIG. 5 shows a schematic representation of a method according to an exemplary embodiment of the present invention.

FIG. 6 shows a schematic representation of a method according to an exemplary embodiment of the present invention.

FIG. 7 shows a schematic representation of a device according to an exemplary embodiment of the present invention.

FIG. 8 shows a schematic representation of a device according to an exemplary embodiment of the present invention.

### DETAILED DESCRIPTION OF EXAMPLE EMBODIMENTS

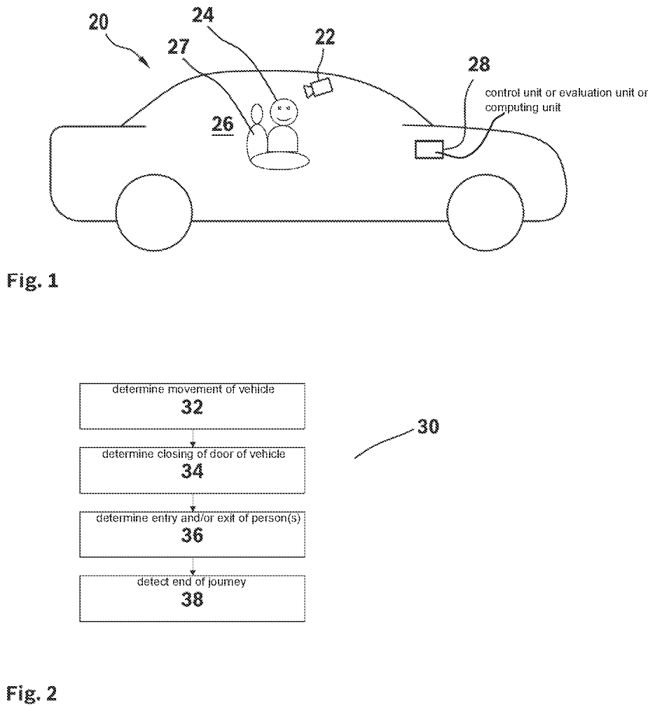

FIG. 1 shows a schematic representation of a vehicle 20, for example a motor vehicle, for example a car, comprising an observation device 22 for observing one or more vehicle occupants 24 or passengers 24 or persons 24 in the vehicle 24. The vehicle 20 has in particular an interior 26 or a vehicle interior 26, wherein in particular one or more seats 27 can be arranged in the vehicle interior 26 for one or more vehicle occupants 24. Furthermore, the vehicle 20 comprises an observation device 22 for observing the vehicle interior 26 and/or one or more vehicle occupants 24, for example a driver and/or a front-seat passenger and/or one or more further passengers. The observation device 22 can also be referred to as an observation system, a driver monitoring system, an occupant observation system, and/or as a monitoring system. The observation device 22 can be designed, for example, to detect a viewing direction, a body posture and/or the position of the head or the face or the eyes of the vehicle occupant 24 or the fatigue state and/or other vital signs of the vehicle occupant 24. Furthermore, an identity of the vehicle occupant 24 can be detected, for example.

The observation device 22 can be arranged in particular in a dashboard, in an instrument panel, in a steering wheel, on a vehicle roof, on a glazing pane, on a rear view mirror or on a column, for example on an A-pillar and/or a B-pillar of the vehicle 20, or at another location in the vehicle 20.

The observation device 22 can have a recording unit for observing the vehicle occupant 24. In a development, the observation device 22 can comprise a lighting unit for emitting light beams, in particular infrared beams. Alternatively, it is possible for the observation device 22 not to have a separate lighting unit and the vehicle interior or the vehicle occupants may be illuminated by light from an environment.

The lighting unit can in particular be directed toward the vehicle occupant 24 and thus in the direction of the vehicle seat 27 in order to radiate the vehicle occupant 24 with light beams, in particular with infrared beams. In other words, light beams, in particular infrared beams, can be emitted in the direction of the vehicle occupant 24 by means of the lighting unit. The lighting unit can, for example, be designed as a light unit, lighting element, light-emitting diode, LED, OLED and/or laser diode, and/or comprise a light unit, a lighting element, a light-emitting diode, an LED, OLED, and/or a laser diode.

The recording unit can be designed, for example, as an image recording unit, for example as a sensor or as a camera, in particular as an infrared camera module, the recording unit being directed in the direction of the vehicle occupant 24 and thus in the direction of the vehicle seat 27 in order to visually capture the vehicle occupant 24. Due to the design as an infrared camera module, it is possible to carry out observation even at night without the vehicle occupant 24 being brightly illuminated and thereby in particular being disturbed or dazzled.

In other words, the observation device 22 is designed to observe a vehicle interior of a vehicle. The observation device 22 can have a lighting unit for emitting light beams, for example infrared beams, in the direction of the vehicle interior, and a recording unit for receiving light beams, for example infrared beams. The light beams emitted by the lighting unit can preferably be reflective on or in the vehicle interior, wherein the reflected light beams can be steered in the direction of the recording unit.

Furthermore, the observation device 22 has a control unit 28 or an evaluation unit 28 or a computing unit 28 for controlling the lighting unit and/or the recording unit and/or for processing the data recorded by means of the recording unit.

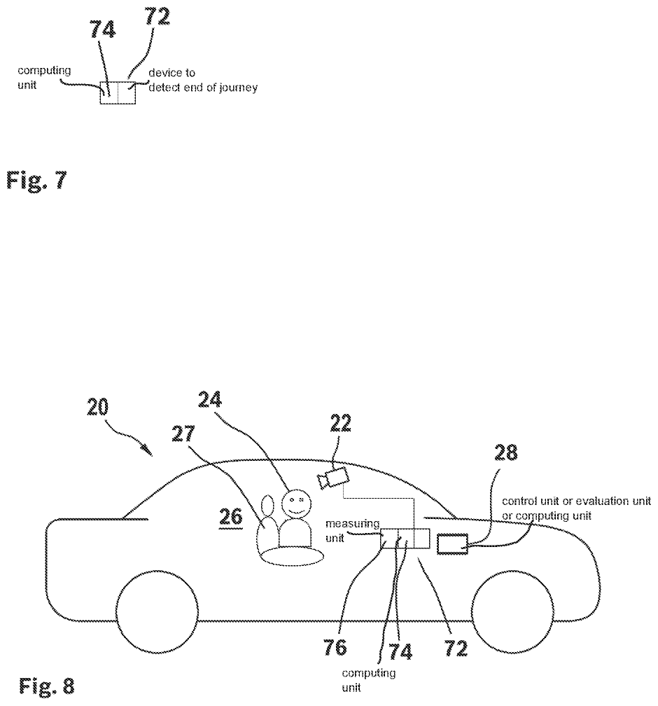

FIG. 2 shows a schematic representation of a method 30 for detecting an end of a journey of a vehicle according to an exemplary embodiment of the present invention. The method 30 can be carried out, for example, by means of the device according to FIG. 7 and/or FIG. 8.

In a first step 32 of the method 30 a movement of the vehicle is determined. Here, for example, it can be detected whether the vehicle is moving in general or whether it is stationary and thus not moving. Advantageously, the movement of the vehicle can be determined by means of acceleration data and an orientation of the vehicle and/or by means of data of a navigation system and/or by means of observation data. In a development, movement data of the vehicle, for example, can be received for this purpose.

The movement of the vehicle can be determined, for example, by means of data from an inertial measurement unit (or IMU) and/or a global navigation satellite system (or GNSS) or GPS data. From the acceleration and orientation of the vehicle provided by means of the IMU an algorithm deduces whether the vehicle is in movement. Alternatively or additionally, the distinction between movement and standstill can be enabled by means of a GNSS module. This can be used, for example, if there is movement even with low acceleration on very good roads.

Alternatively or additionally, vehicle movement detection can also be carried out on a video basis, in that a window region of the vehicle is detected and a movement of the vehicle is deduced from the movement in the window region.

Alternatively or additionally, a position of the vehicle can be determined and in particular a change in position within a predefined minimum period.

In a second step 34 of the method 30, a closing of at least one door of the vehicle is determined. Advantageously, a closing of at least one door of the vehicle can be determined by means of acceleration data of the vehicle and/or by means of audio data and/or by means of observation data. In a development, monitoring data for monitoring a closing of at least one door of the vehicle can for example be received for this purpose.

The closing of at least one door of the vehicle can be determined, for example, by means of data from an inertial measurement unit. A vibration, which is triggered in particular by closing the door, creates a characteristic acceleration of the stationary vehicle. Alternatively or additionally, the closing of at least one door of the vehicle can be determined by means of an audio recording. Alternatively or additionally, the closing of at least one door can also be detected on a video basis, in that, for example, a door region is detected and the closing is detected from the visual change of the door region.

In a third step 36 of the method 30, an entry and/or an exit of one or more persons into or from the vehicle is determined. In other words, it is determined whether one or more persons enter the vehicle or whether one or more persons exit the vehicle. For this purpose, for example, observation data of a vehicle interior can be received. In a development, an entry and/or an exit of the one or more persons into or from the vehicle can be determined by means of video-based person recognition. In other words, persons can be identified, whereby it can be recognized which persons enter the vehicle and/or which persons, in particular the same or different persons, exit the vehicle. For this purpose, in particular the number of persons in the vehicle and/or the persons to have newly entered the vehicle can be precisely determined. In an advantageous embodiment, an evaluation of observation data for determining an entry and/or an exit of the one or more persons into or from the vehicle can be learned by means of a neural network. In this way, for example, occluded places in the vehicle can be learnt, wherein the occluded places can be occluded, for example, by seats.

In other words, persons in the vehicle can be detected. For example, a neural network can be used which detects any number of persons simultaneously in the camera image. The advantage of the neural network is that it can be trained in particular to suit the specific application area in the vehicle. Use in any vehicle can result in occlusions, for example, depending on the characteristics of the vehicle and/or the installation position.

The neural network can also recognize persons with occlusions, particularly in a data-driven manner. Advantageously, person detection at a high frequency can thereby be avoided, but instead only be carried out selectively. Due to possible complete occlusions, which can last a long time, a higher detection frequency increases the accuracy of the method.

The first step 32, the second step 34 and the third step 36 can be carried out in any order and/or in parallel.

In a fourth step 38 of the method 30, an end of the journey of the vehicle is then detected when it is determined that the movement of the vehicle is equal to zero, and when a closing of at least the one door of the vehicle is determined and when an entry and/or an exit of the one or more persons into or from the vehicle is detected. These three criteria are connected in particular by means of an AND operation, whereby an end of the journey is only determined when all three criteria are met. Advantageously, it can then be determined that if the acceleration data is equal to zero then the movement of the vehicle is equal to zero. Alternatively or additionally, it can then be determined that the movement of the vehicle is equal to zero if a position of the vehicle does not change, in particular for one or within a prespecified minimum period. Alternatively or additionally, it can then be determined that the movement of the vehicle is equal to zero if GPS data do not change, in particular for one or within a prespecified minimum period.

Alternatively or additionally, an end of the journey of the vehicle can then be detected when no movement of the vehicle is determined and when a closing of at least the one door of the vehicle is determined and when an entry and/or an exit of the one or more persons into or from the vehicle is detected.

Alternatively or additionally, an end of the journey of the vehicle can then be detected when an unchanged position is determined for one or within a prespecified minimum period and when a closing of at least one door of the vehicle is determined and when an entry and/or an exit of the one or more persons into or from the vehicle is detected.

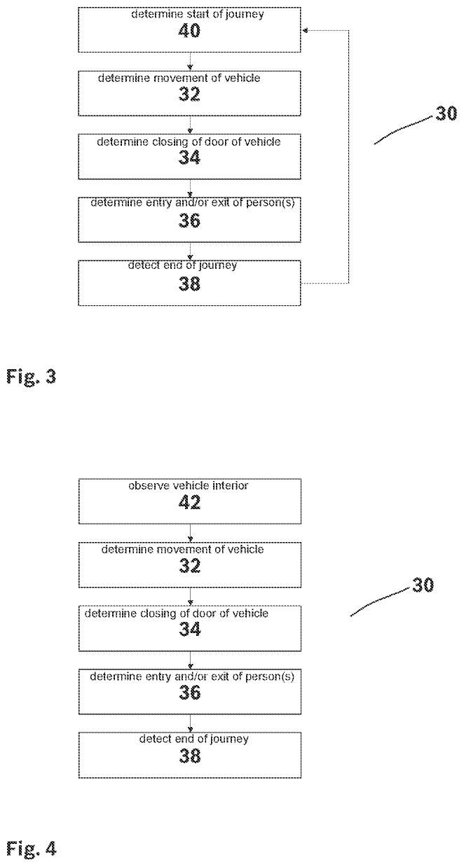

FIG. 3 shows a schematic representation of a method 30 for detecting an end of a journey of a vehicle according to an exemplary embodiment of the present invention. The method 30 can be carried out, for example, by means of the device according to FIG. 7 and/or FIG. 8. The method 30 according to FIG. 3 can be designed, for example, according to the method 30 according to FIG. 2. The method 30 according to FIG. 3 thus comprises the first step 32, the second step 34, the third step 36, and the fourth step 38.

In this advantageous embodiment, the method 30 has in addition a fifth step 40. In the fifth step 40 of the method 30, a start of a journey is determined. A start of a journey can in particular be determined after it has been determined that the movement of the vehicle is equal to zero, and after a closing of the door of the vehicle has been determined and after it has been detected that one or more persons have exited and/or entered the vehicle.

In an alternative or additional embodiment, a start of a journey can be detected or determined, for example, after the end of a journey has been determined. In other words, after an end has been determined in the fourth step 38, a new journey can begin, whereby a start of a new, further journey is detected. This is shown in particular by means of the arrow from the fourth step 38 to the fifth step 40. After the fifth step 40 and thus the determination of the start of a journey, the first step 32, the second step 34, the third step 36 and the fourth step 38 can then carried out. An end of the further journey can be determined, in particular, when it is determined again that the movement of the vehicle is equal to zero, and when a closing of at least one door of the vehicle is determined again, and when an entry and/or an exit of one or more persons into or from the vehicle is detected again.

In other words, a journey can be recognized as a driving cycle or as a closed driving cycle with a start and an end.

Advantageously, a plurality of journeys can be carried out one after the other.

FIG. 4 shows a schematic representation of a method 30 for detecting an end of a journey of a vehicle according to an exemplary embodiment of the present invention. The method 30 can be carried out, for example, by means of the device according to FIG. 7 and/or FIG. 8. The method 30 according to FIG. 4 can be designed, for example, according to the method 30 according to FIG. 2 and/or FIG. 3. The method 30 according to FIG. 4 thus comprises the first step 32, the second step 34, the third step 36, and the fourth step 38. Advantageously, the method 30 according to FIG. 4 can comprise in addition the fifth step 40.

In this advantageous embodiment, the method 30 comprises in addition a sixth step 42. In the sixth step 42 of the method 30, a vehicle interior is observed. The sixth step 42 can be carried out before the first step 32 or parallel to the first step 32 and/or parallel to the second step 34. Observation of the vehicle interior can be carried out, for example, by means of an observation device. The observation device can, for example, be designed according to FIG. 1 and/or be arranged in a vehicle. In particular, one or more persons can be present in the vehicle interior. In particular, the persons can thus be observed. Advantageously, the vehicle interior can be observed in order to generate observation data for determining an entry and/or an exit of one or more persons into or from the vehicle and/or for determining a movement of the vehicle. In other words, by means of the observation data, an entry and/or exit of one or more persons can be detected.

Alternatively or additionally, a movement of the vehicle can be determined by means of the observation data. For example, this can be determined by analyzing the observation data which are recorded in the region of the windows with regard to a movement of the vehicle. For example, the regions of the vehicle where the windows are located and thus enable a view of the surroundings can be evaluated by means of an evaluation algorithm. In a development, a closing of at least one door of the vehicle can be determined by means of the observation data. In a development, for example, an opening of at least one door of the vehicle could additionally be determined first in a further step.

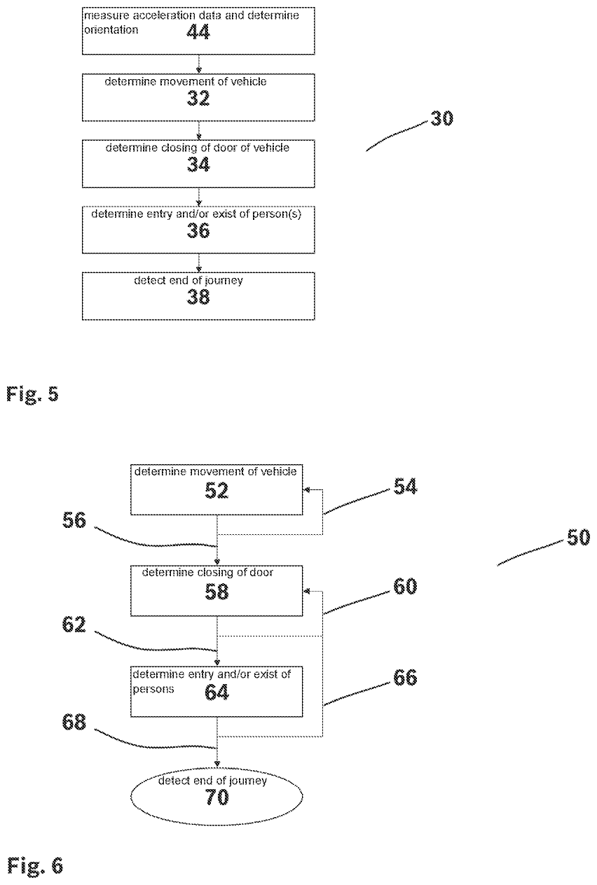

FIG. 5 shows a schematic representation of a method 30 for detecting an end of a journey of a vehicle according to an exemplary embodiment of the present invention. The method 30 can be carried out, for example, by means of the device according to FIG. 7 and/or FIG. 8. The method 30 according to FIG. 5 can be designed, for example, according to the method 30 according to FIG. 2, FIG. 3 and/or FIG. 4. The method 30 according to FIG. 5 thus comprises the first step 32, the second step 34, the third step 36, and the fourth step 38. Advantageously, the method 30 according to FIG. 5 can comprise in addition the fifth step 40. In a further development, the method 30 according to FIG. 5 can in addition comprise the sixth step 42.

In this advantageous embodiment, the method 30 in addition comprises a seventh step 44. In the seventh step 44 of the method 30, acceleration data of the vehicle is measured and an orientation of the vehicle is determined. The measurement of the acceleration data and determination of the orientation of the vehicle can in particular be used for determining a movement of the vehicle and/or for determining a closing of at least the one door of the vehicle. In other words, a movement of the vehicle can be determined by means of the acceleration data and the orientation of the vehicle. Alternatively or additionally, a closing of at least one door of the vehicle can be determined by means of the acceleration data and the orientation of the vehicle. Measuring the acceleration data can be carried out, for example, with an inertial measurement unit or IMU.

FIG. 6 shows a schematic representation of a method 50 for detecting an end of a journey of a vehicle according to an exemplary embodiment of the present invention. The method 50 can be carried out, for example, by means of the device according to FIG. 7 and/or FIG. 8. The method 50 according to FIG. 6 can be designed, for example, according to the method according to FIG. 2, FIG. 3, FIG. 4 and/or FIG. 5.

In this advantageous embodiment, the steps of checking the different criteria are carried out in a sequence.

In a first step 52 of the method 50 a movement of the vehicle is determined. The determination of the movement of the vehicle in the first step 52 can be designed, for example, according to the first step of the method according to FIG. 2, FIG. 3, FIG. 4 and/or FIG. 5. If it is detected here that the vehicle is moving, corresponding to the arrow 54 the first step 52 will be started again and thus be executed again. If it is detected or determined that the vehicle is not moving and thus there is a standstill of the vehicle, then corresponding to the arrow 56 it is possible to proceed to a next, second step 58.

In the second step 58 of the method 50, a closing of at least one door of the vehicle is determined. The determination of the movement of the vehicle in the second step 58 can be designed, for example, according to the second step of the method according to FIG. 2, FIG. 3, FIG. 4 and/or FIG. 5. If no closing of a door is detected in this case, corresponding to the arrow 60 the second step 58 is started again and thus executed again. Alternatively, the first step 52 can be started again next. If it is detected or determined that at least one vehicle door is being closed or has been closed, it is possible to proceed corresponding to the arrow 62 to a next, third step 64.

In the third step 64 of the method 50, an entry and/or an exit of one or more persons into or from the vehicle is determined. The determination in the third step 64 can be designed, for example, according to the third step of the method according to FIG. 2, FIG. 3, FIG. 4 and/or FIG. 5. If no entry and/or exit of one or more persons into or from the vehicle is detected in this case, corresponding to the arrow 66 the second step 58 is started again and the second step 58 is thus executed again. If it is detected or determined that at least one person has entered the vehicle or has exited the vehicle, it is possible to proceed corresponding to the arrow 62 to a next, fourth step 70. It is advantageously possible to proceed corresponding to the arrow 62 to the next, fourth step 70 if the number of persons in the vehicle has changed. It is advantageously possible to proceed corresponding to the arrow 68 to the next, fourth step 70 if there are different people in the vehicle than before.

In the fourth step 70 of the method 50, an end of the journey of the vehicle is detected. The detection in the fourth step 64 can be designed, for example, according to the fourth step of the method according to FIG. 2, FIG. 3, FIG. 4 and/or FIG. 5. In other words, in the fourth step 70, an end of the journey is then detected when it is determined in the first step 52 that the movement of the vehicle is equal to zero, and when, in the second step 58, a closing of at least the one door of the vehicle is determined, and when in the third step 64 an entry and/or an exit of the one or more persons into or from the vehicle is detected. Advantageously, when an end of the journey of the vehicle is detected, a start of a new journey can be determined or generated.

The combination of these three detections or determinations results in the final detection of person (s) entering and person (s) exiting, from which the automatic journey detection is derived. In this case, in particular in any vehicles, a start of the journey and an end of the journey can be automatically detected with time accuracy. Furthermore, additional information, such as a number of persons, can be specified in a journey sequence. In this case, it is not necessary for the driver to exit or otherwise perform a manual activity.

The method 50 can be used in any vehicles that perform person or goods delivery services in order to obtain a journey sequence. In a further development, this can be used for statistical improvements in the service and/or for the subsequent findability of video- and audio-documented journeys.

In other words, the method can be applied independently of the vehicle type and/or in particular independently of the camera type. Independence means that, for example, no vehicle- and/or camera-specific calibration is necessary.

In an advantageous embodiment, an entry or exit of person (s) can only be detected by all three functions being triggered. This makes it possible, for example, for the detection of the closing of the door to be set sensitively, since the vehicle movement detection is working reliably. This can furthermore mean that no entry or exit will be detected, even if a closing of the door has been incorrectly detected when the vehicle is in movement. The same can apply to the change in the number of persons in the vehicle. Even if a person is completely occluded for a short time, this will in particular not be classified as an exit, as long as the standstill of the vehicle and a closing of the door are not detected at the same time.

When used in any vehicles with varying installation positions, automatic journey detection can be reliably detected by this combination of the sub-functions.

This automatic journey detection can advantageously be used in particular by downstream algorithms for different application scenarios. For example, if additional persons enter or only some of the persons exit, this can be grouped into a pool ride, for example. With the additional use of a person recognition, the pool ride, for example two passengers in the vehicle and a third passenger entering, can be distinguished from a simultaneous exit and entry scenario, for example both passengers exiting and three new passengers entering directly afterwards.

Furthermore, the use is not limited to passenger journeys, but can also be used for courier journeys. A specific driver detection and also a locking detection adapted for the trunk can thereby be used to distinguish a courier journey more precisely from a solitary journey. With the aid of the GNSS signal, a statistic could be generated—for example, which places of residence typically order from which restaurants.

FIG. 7 shows a schematic representation of a device 72 for detecting an end of a journey of a vehicle according to an exemplary embodiment of the present invention. The device can, for example, carry out a method according to FIG. 2, FIG. 3, FIG. 4, FIG. 5 and/or FIG. 7. The device 72 can be arranged, for example, in a vehicle, in a mobile device or as a mobile device and/or in an external server. In other words, the device can be arranged in a vehicle and/or can be used in a retrofittable dashboard camera.

The device 72 is designed to determine a movement of the vehicle. The movement can, for example, be determined according to the first step according to the method according to FIG. 2, FIG. 3, FIG. 4, FIG. 5 and/or FIG. 7. The movement of the vehicle can be determined, for example, by means of acceleration data and an alignment of the vehicle and/or by means of data of a navigation system and/or by means of observation data.

The device 72 is also designed to determine a closing of at least one door of the vehicle. The closing of at least one door of the vehicle can, for example, be determined according to the second step according to the method according to FIG. 2, FIG. 3, FIG. 4, FIG. 5 and/or FIG. 7. A closing at least the one door of the vehicle can be determined, for example, by means of acceleration data of the vehicle and/or by means of audio data and/or by means of observation data.

The device 72 is further designed to determine an entry and/or an exit of one or more persons into or from the vehicle. The entry and/or exit of the one or more persons into or from the vehicle can, for example, be determined according to the third step according to the method according to FIG. 2, FIG. 3, FIG. 4, FIG. 5 and/or FIG. 7. An entry and/or an exit of the one or more persons into or from the vehicle can advantageously be determined by means of video-based person recognition.

The device 72 is further designed to detect the end of the journey of the vehicle when it is determined that the movement of the vehicle is equal to zero, and when a closing of at least the one door of the vehicle is determined and when an entry and/or an exit of the one or more persons into or from the vehicle is detected. The detection of the end of the journey can, for example, be determined according to the fourth step according to the method according to FIG. 2, FIG. 3, FIG. 4, FIG. 5 and/or FIG. 7.

The steps can advantageously be carried out by means of a computing unit 74. The device can be designed, for example, as a computing unit. Alternatively, the computing unit 74 can in particular be part of the device 72.

FIG. 8 shows a schematic representation of a device 72 for detecting an end of a journey of a vehicle according to an exemplary embodiment of the present invention. In this advantageous embodiment, the device 72 is arranged in the vehicle 20. The device 72 is designed in particular according to the device according to FIG. 7. The device can, for example, carry out a method according to FIG. 2, FIG. 3, FIG. 4, FIG. 5 and/or FIG. 7. The vehicle can be designed, for example, according to the vehicle according to FIG. 1. The device 72 can be arranged directly in the vehicle 20 and/or can be used in a retrofittable dashboard camera.

In this advantageous embodiment, the device 72 comprises an observation device 22 for observing a vehicle interior 26 in order to generate observation data. The observation device 22 can, for example, be designed according to FIG. 1 and/or be arranged in the vehicle 20. In an alternative or additional embodiment, the observation device 22 can take the form of a video camera arranged in a dashboard camera, for example a retrofittable dashboard camera. The observation data can be used by means of the device 72 to determine an entry and/or exit of the one or more persons 24 into or from the vehicle 20 and/or to determine a movement of the vehicle 20.

Furthermore, the device 72 comprises a measuring unit 76 for measuring acceleration data and an orientation of the vehicle 20 in order to determine a movement of the vehicle and/or to determine a closing of at least the one door of the vehicle. The measuring unit 76 can be designed, for example, as an inertial measurement unit 76.

In a further development, the device 72 can have a microphone for recording an audio signal, wherein the audio signal can be used for detecting a closing of at least one door.

In one exemplary embodiment, the device 72 can comprise a navigation system and/or a navigation satellite system or GNSS, wherein a movement of the vehicle can be detected by means of the signal of the navigation system and or of the GNSS.

What is claimed is:

1. A method for detecting an end of a journey of a vehicle, comprising the following steps:
determining a movement of the vehicle;
determining a closing of at least one door of the vehicle;
determining an entry and/or an exit of one or more persons into or from the vehicle;
detecting the end of the journey of the vehicle when it is determined that the movement of the vehicle is equal to zero, and when the closing of at least the one door of the vehicle is determined, and when the entry and/or the exit of the one or more persons into or from the vehicle is detected.

2. The method according to claim 1, further comprising the following steps:
receiving movement data of the vehicle;
receiving monitoring data of the closing of the at least one door of the vehicle; and
receiving observation data of a vehicle interior.

3. The method according to claim 1, further comprising observing a vehicle interior to generate observation data for the determining of the entry and/or the exit of the one or more persons into or from the vehicle and/or to determine a movement of the vehicle.

4. The method according to claim 1, further comprising measuring acceleration data and determining an orientation of the vehicle to determine the movement of the vehicle and/or in to determine the closing of the at least the one door of the vehicle.

5. The method according to claim 1, wherein the movement of the vehicle is determined: (i) using acceleration data and an orientation of the vehicle, and/or (ii) using data of a navigation system, and/or (iii) using observation data.

6. The method according to claim 1, wherein the closing of the at least the one door of the vehicle is determined: (i) using acceleration data of the vehicle, and/or (ii) using audio data, and/or (iii) using observation data.

7. The method according to claim 1, wherein the entry and/or the exit of the one or more persons into or from the vehicle is determined using video-based person recognition.

8. The method according to claim 1, wherein an evaluation of observation data to determine the entry and/or the exit of the one or more people into or from the vehicle is learned using a neural network.

9. The method according to claim 1, wherein a start of the journey is determined after it has been determined that the movement of the vehicle is equal to zero, and after a closing of the door of the vehicle has been determined and after it has been detected that one or more persons have exited and/or entered the vehicle.

10. The method according to claim 1, wherein, after the end of the journey has been detected, a start of a further journey of the vehicle is determined.

11. The method according to claim 10, wherein an end of the further journey is determined when it is determined again that a movement of the vehicle is equal to zero, and a closing of at least one door of the vehicle is determined again, and an entry and/or an exit of one or more persons into or from the vehicle is determined again.

12. A device configured to detect an end of a journey of a vehicle, the device being configured to:
determine a movement of the vehicle;
determine a closing of at least one door of the vehicle;
determine an entry and/or an exit of one or more persons into or from the vehicle; and
detect the end of the journey of the vehicle, when it is determined that the movement of the vehicle is equal to zero, and when the closing of the at least the one door of the vehicle is determined, and when the entry and/or the exit of the one or more persons into or from the vehicle is detected.

13. The device according to claim 12, wherein the device comprises an observation device configured to observe a vehicle interior in order to generate observation data: (i) for the determining of the entry and/or the exit of the one or more persons into or from the vehicle, and/or (ii) for determining the movement of the vehicle.

14. The device according to claim 12, wherein the device comprises a measuring unit configured to measure acceleration data and an orientation of the vehicler: (i) to determine the movement of the vehicle, and/or (ii) to determine the closing of at least the one door of the vehicle.

15. A vehicle, comprising:
a device configured to detect an end of a journey of the vehicle, the device being configured to:
determine a movement of the vehicle;
determine a closing of at least one door of the vehicle;
determine an entry and/or an exit of one or more persons into or from the vehicle; and
detect the end of the journey of the vehicle, when it is determined that the movement of the vehicle is equal to zero, and when the closing of the at least the one door of the vehicle is determined, and when the entry and/or the exit of the one or more persons into or from the vehicle is detected.
